(19) United States
(12) Patent Application Publication
(10) Pub. No.: US 2008/0292761 A1
(43) Pub. Date: Nov. 27, 2008

(54) Steam Cooking Method and Oven with an Improved Water Supply

(76) Inventors: Nicole Baratin, Loury (FR); Olivier Vincent, Beaugency (FR); Sebastien Genevier, Orleans (FR)

Correspondence Address: YOUNG & THOMPSON, 209 Madison Street, Suite 500, ALEXANDRIA, VA, 22314, US

(21) Appl. No.: 10/578,364

(22) PCT Filed: Nov. 5, 2004
(86) PCT No.: PCT/FR04/02855

§ 371 Date: Jul. 5, 2006

(30) Foreign Application Priority Data
Nov. 6, 2003 (FR) 0313070

(51) Int. Cl. A47J 27/04; F22B 1/28

(52) U.S. Cl. 426/510; 99/330; 392/402

(57) ABSTRACT

The inventive steam cooking method is designed to be carried out in a cooking oven (1) provided with a steam generator (2, 4). The steam generator (2,4) comprises a water evaporation vessel (201) and a heating unit (200) which is in thermal contact with the water evaporation vessel (201). The method comprises a cooking phase, during which the water supply for the water evaporation vessel (201) is regulated. Regulation of the water supply comprises the following phases: temperature increase is detected in the heating unit (200) whereupon the supply of water to the water evaporation vessel (201) is triggered in the case of said temperature increase. The supply of water for the steam generator (2, 4) is thus triggered on the basis of a simple, reliable detection which is adapted to mass consumer products.

The invention relates generally to the field of steam cooking. The invention relates more particularly to a steam cooking method and oven and a steam generator in which the water running out is detected to command feeding with more water.

Regulating the feed of water to the steam generator integrated into a steam cooking oven has certain advantages.

Regulating the water feed enables the provision of a measurable quantity of water. It is therefore possible to prevent too great a quantity of water being contained in a heated evaporation element of the generator.

Detecting the time at which feeding water to the evaporation element should be triggered gives rise to a particular technical problem in that this time must be detected simply, reliably and at a cost suited to consumer goods.

EP-0673615-B1 discloses a steam cooking appliance in which the water feed is controlled by measuring the temperature inside a cooking enclosure of the appliance.

The appliance running out of water causes a reduction in the quantity of steam in the enclosure. The reduction in the quantity of steam leads to a drop in temperature that is detected by a temperature sensor in the enclosure. Detecting the drop in temperature in the enclosure commands the water feed.

Although simple and economical, the solution proposed by EP-0673615-B1 is not entirely satisfactory in respect of detection time and the independence of detection from events other than running out of water.

In the appliance disclosed in EP-0673615-B1, the measurement time is relatively long, since it is linked to the thermal constant of the enclosure, which may be high, and to the need to have a significant drop in temperature for detection to be reliable. With regard to the independence of detection, a temperature drop in the enclosure may be caused by an event other than the “running out of water” event, for example by the untimely opening of the door of the enclosure by the user. Additional means, including discriminatory logic, must therefore be provided to prevent triggering of water feed in the event of opening the door.

It is therefore desirable to provide a steam cooking method guaranteeing improved detection of running out of water in the steam generator with simple technical means of relatively low cost.

The steam cooking method of the invention is implemented in a cooking oven equipped with a steam generator comprising a water evaporation vessel and a heater unit in thermal contact with the water evaporation vessel. The method includes a cooking phase during which feeding of water to the water evaporation vessel is regulated and is characterized in that the water feed regulation comprises the steps of:

detecting an increase of a temperature in the heater unit, and

triggering feeding of water to the water evaporation vessel when said temperature increase is detected.

According to another feature, a temperature increase corresponding to the evaporation of a predetermined quantity of water contained in the water evaporation vessel is detected in the step of detecting a temperature increase in order to trigger the feed of water.

It is thus possible to ensure fast and independent detection of the water running out in the evaporation vessel.

To start the generation of steam as soon as the steam generator is energized, the method of the invention may further include a step of first feeding water to the water evaporation vessel at the beginning of the cooking phase.

According to another preferred feature, the temperature increase is detected if the temperature exceeds a predetermined first threshold temperature.

To be more precise, the first threshold temperature is preferably significantly higher than a stabilization temperature in the heater unit. The stabilization temperature is reached when the water evaporation vessel contains water and when the heater unit is heating the water evaporation vessel.

For example, in one preferred embodiment, the first threshold temperature is from approximately 110° C. to 130° C. and/or the stabilization temperature is from approximately 100° C. to 120° C.

For detection to be reliable, the method of the invention preferably uses a relatively large temperature difference between the stabilization temperature and the first threshold temperature.

According to another feature, water is preferably fed by gravity, by opening a water feed circuit for a predetermined time.

According to a further feature of the method of the invention, it is possible to decide to deactivate the heater unit as a safety measure on the basis of the first threshold temperature and/or a safety threshold temperature being exceeded in the heater unit. This two-fold safety feature therefore prevents overheating of the heater unit.

The method of the invention advantageously comprises, in a steam evacuation phase, a step of continuing to heat the water evaporation vessel until detection of a temperature increase indicating that any water remaining in the water evaporation vessel has completely evaporated. This eliminates any water remaining in the steam generator at the end of cooking.

Another object of the present invention is to provide a steam generator in which the prior art drawbacks referred to are removed.

The steam generator of the invention, in particular for a cooking oven, includes a water evaporation vessel, a heater unit in thermal contact with the water evaporation vessel and means for regulating feeding of water to the water evaporation vessel, and is characterized in that the water feed regulation means include means for detecting an increase of a temperature in the heater unit, and means for commanding feeding of water to the water evaporation vessel if the temperature increase is detected.

The temperature increase detector means preferably include means for indicating that a first threshold temperature is exceeded in the heater unit.

According to another feature, the steam generator of the invention also includes means for indicating that a second threshold temperature is exceeded in the heater unit.

The means for indicating that a first threshold temperature has been exceeded and the means for indicating that a second threshold temperature has been exceeded advantageously comprise a temperature sensor and a temperature limiter, respectively.

In the steam generator of the invention, the temperature sensor is specifically dedicated to detecting the water running out but may additionally be employed as a safety cut-out for deactivating the heater unit. The temperature limiter is dedicated in particular to deactivating the heater unit as a safety measure.

The water feed control means preferably include a solenoid valve and a control circuit. The control circuit commands opening of the solenoid valve for a predetermined time if it receives from the temperature increase detector means information indicating detection of the temperature increase.

In one particularly preferred embodiment of the steam generator of the invention, the water evaporation vessel and the heater unit are formed in one piece from a block of material of good thermal conductivity, the water evaporation vessel and the heater unit being formed in the upper and lower portions of this block of material, respectively.

In the above embodiment, the heater unit is preferably equipped with a heater resistor crimped onto the lower portion of the block of material. The temperature sensor and the temperature limiter are advantageously also mounted on the lower portion of the block of material and in thermal contact therewith.

The block of material is a block of aluminum, for example.

Another object of the present invention is to provide a steam cooking oven for implementing the steam cooking method of the invention.

A further object of the invention is to provide a steam cooking oven into which a steam generator of the invention is integrated.

A preferred embodiment of the steam cooking oven of the invention comprises a temperature probe for measuring an enclosure temperature inside an enclosure of the oven, and a control circuit for regulating the enclosure temperature by controlling the heater unit according to information supplied by the temperature probe and a set point temperature.

Regulating the temperature inside the cooking enclosure of the oven improves the quality of cooking.

Other features and advantages of the present invention will become apparent on reading the following description of preferred embodiments of a method, a steam generator and a steam cooking oven of the invention given with reference to the appended drawings, in which:

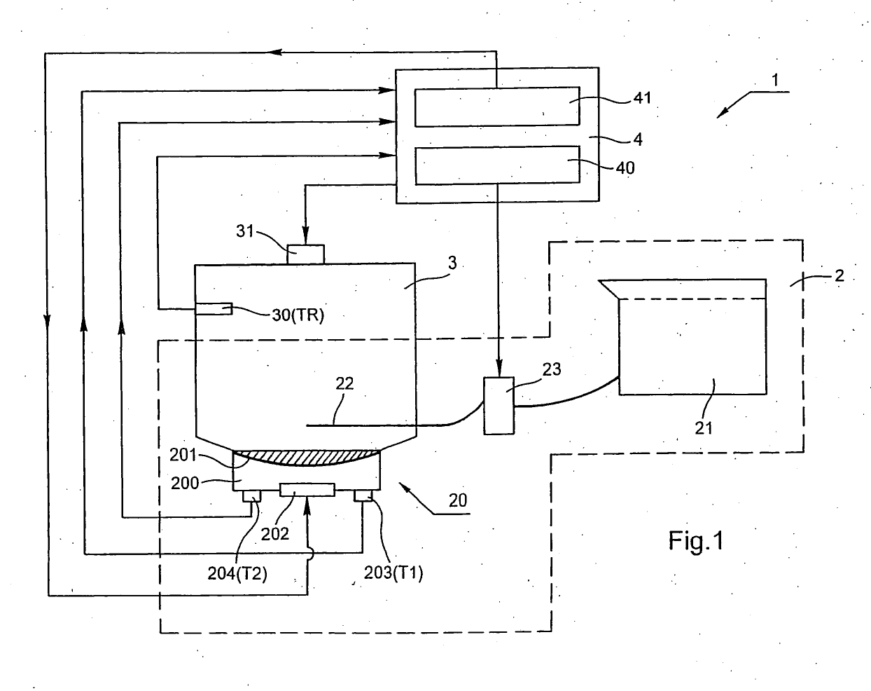

FIG. 1 is a simplified diagram of a preferred embodiment of the steam cooking oven of the invention, and

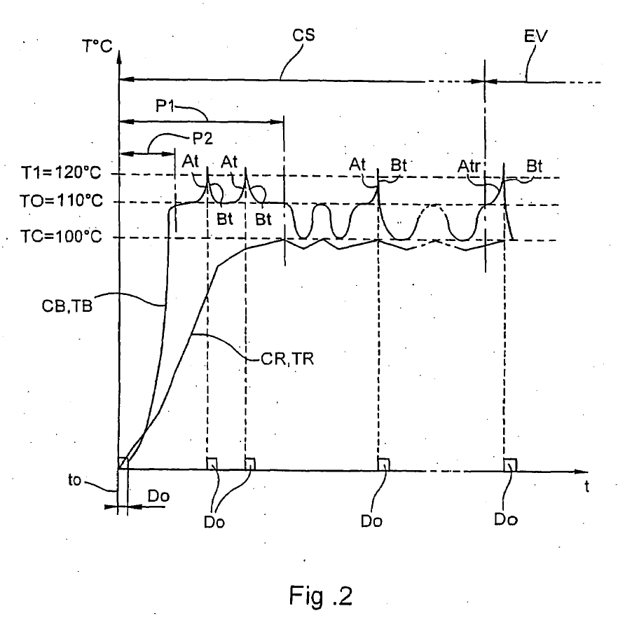

FIG. 2 shows two curves of the evolution of the temperature in a cooking enclosure and in a heater unit of the FIG. 1 oven, respectively.

Referring to FIG. 1, a steam cooking oven 1 of the present invention essentially comprises a steam generator 2, a cooking enclosure 3 and an oven control circuit 4.

The steam generator 2 essentially includes a steam generator unit 20, a water feed system comprising elements 21, 22 and 23, and a water feed control circuit 40 included in the circuit 4.

The steam generator unit 20 is made from materials having good thermal conductivity, for example aluminum.

In this preferred embodiment, the steam generator unit 20 comprises an upper portion forming a water evaporation vessel 201 and a lower portion forming a heater unit 200 made from a single piece of aluminum.

According to a variant, the water evaporation vessel 201 and the heater unit 200 may take the form of two separate parts that are assembled together.

The heater unit 200 is equipped with a heater resistor 202, a temperature sensor 203 and a temperature limiter 204. These components 202, 203 and 204 may be mounted at different locations in the heater unit 200.

The heater resistor 202 is preferably crimped to the heater unit 200 to achieve good thermal contact.

In association with a threshold electronic circuit (not shown) included in the oven control circuit 4, for example, the temperature sensor 203 has the function of indicating if a first threshold temperature T1 is exceeded in the heater unit 200. The limiter 204 has the function of indicating if a second temperature threshold T2 is exceeded in the heater unit 200. Here the limiter 204 is a switch-type temperature limiter having a closed state and an open state, for example a switch of the bimetallic strip type. If the safety threshold temperature T2 is exceeded in the heater unit 200, the limiter 204 changes state, for example by switching over to the open state. The temperature T2 is a safety threshold temperature higher than the temperature T1.

In this preferred embodiment, the threshold temperature T1 is typically 120° C. More generally, in other embodiments, the threshold temperature T1 may be from approximately 110° C. to 130° C.

According to the invention, the threshold temperature T1 is used to control the water feed to the steam generator 2. This aspect of the invention is described in more detail hereinafter.

According to a variant, a temperature sensor associated with a threshold electronic circuit may be used for the limiter 204.

The water feed system is of the gravity feed type and comprises the components 21, 22 and 23, as indicated above.

The component 21 is a water reservoir, the component 22 is a water feed pipette and the component 23 is a solenoid valve.

The water feed pipette 22 has a first end located at the center of the vessel 201. A second end of the water feed pipette 22 is connected to the reservoir 21 via the solenoid valve 23 and a connecting pipe in order to form a water feed circuit.

Inside the oven 1, the reservoir 21 is disposed so that the water level of the reservoir 21 is above that of the water feed pipette 22. Water therefore circulates by gravity between the reservoir 21 and the vessel 201.

The circulation of water between the reservoir 21 and the vessel 201 via the pipette 22 is commanded by the solenoid valve 23. The solenoid valve 23 is operated by the water feed control circuit 40.

As shown in FIG. 1, the water feed control circuit 40 is preferably integrated into the oven control circuit 4.

The water feed control circuit 40 operates the solenoid valve 23 in particular according to information supplied by the sensor 203. To this end an open/close control signal is supplied to the solenoid valve 23 by the water feed control circuit 40.

The cooking enclosure 3 is equipped in particular with a temperature probe 30 and a thermal activator 31. The cooking enclosure 3 is preferably also equipped with a heating blanket and a ventilation/cooling fan (not shown).

The temperature probe 30 supplies a measured value of a temperature TR inside the cooking enclosure 3 to the oven control circuit 4.

In the conventional way, the thermal activator 31 is energized by the oven control circuit 4 and operates (opens/closes) a steam exhaust valve (not shown).

The oven control circuit 4 is based on a microcontroller or a microprocessor, for example. In addition to the water feed control circuit 40, the oven control circuit 4 includes in particular a control circuit for the heater resistor 41 and various control and safety logic circuits (not shown).

The heater resistor control circuit 41 constitutes a loop for regulating the temperature TR inside the enclosure 3.

In this preferred embodiment, the temperature TR inside the enclosure 3 is regulated to a set point temperature TC of approximately 100° C.

The regulation of the temperature TR is preferably of the all-or-nothing type. The power output of the heater resistor control circuit 41 is connected to the heater resistor 202 and is active when the temperature TR is below the set point temperature TC. The supply of power to the heater resistor 202 is cut off if the temperature TR rises above the set point temperature TC.

The operation of the oven control circuit 4 and more particularly that of the water feed control circuit 40 are described in more detail next and additionally with reference to FIG. 2.

In FIG. 2, a curve CR shows the evolution of the temperature TR inside the enclosure 3 and a curve CB shows the evolution of a temperature TB at the level of the sensor 203 in the heater unit 200.

The curves CR and CB are shown during a cooking phase CS and a steam evaporation phase EV of a cycle of operation of the oven 1.

The cooking phase CS includes a period P1 of raising the temperature in the enclosure 3.

At a time t0 corresponding to the beginning of the cooking phase CS, the water feed control circuit 40 commands opening of the solenoid valve 23 for a duration D0. The duration D0 is determined to ensure appropriate filling of the vessel 201. Moreover, at the time t0, the heater resistor 202 is energized by the heater resistor control circuit 41.

As the curve CR shows, the temperature TR inside the enclosure 3 reaches the set point temperature TC=100° C. at the end of the temperature raising period P1. The very good thermal conductivity of the material of the steam generator unit 20 and the crimping of the heater resistor 202 to the heating unit 200 enable a rapid rise in temperature. Because of the regulation effected by the circuit 41, the temperature TR stabilizes at an average value of about 98° C.

In the curve CB, a period P2 of the temperature of the heater unit 200 rising begins at the time t0 and ends when the temperature TB reaches a stabilization temperature T0 approximately equal to 110° C. in this preferred embodiment. More generally, in other embodiments, the stabilization temperature T0 may take a value from approximately 100° C. to 120° C. The temperature TB is effectively stabilized at T0 if the heater resistor 202 is energized and the vessel 201 contains water.

After the heater resistor 202 is switched on at the time to, the enclosure rapidly saturates with steam as a result of evaporation of the water contained in the vessel 201.

For correct operation of the steam generator 2, the water evaporation vessel 201 should preferably contain water at all times. It is therefore necessary to detect exhaustion of a predetermined quantity of water in the vessel 201 in order to command opening of the solenoid valve 23.

According to the invention, the occurrence in the curve CB of a rapid rise At of the temperature TB when the water runs out in the vessel 201 triggers the feeding of water to the vessel 201.

The temperature rise At is detected by the sensor 203 if the temperature TB exceeds the threshold temperature T1=120° C. corresponding to the sensor 203. The water feed control circuit 40 then operates (opens) the solenoid valve 23 for the time D0, or possibly a more suitable different time, to fill the vessel 201.

If the heater resistor 202 is energized, feeding the vessel 201 with water causes a drop Bt of the temperature TB toward the stabilization temperature. T0. If the supply of power to the heater resistor 201 is cut off by the circuit 41, for example by virtue of the all-or-nothing regulation of the temperature TR, the temperature TB tends to fall toward the temperature of the enclosure (TC=100° C.).

Note that the temperature TB persistently exceeding T1=120° after the solenoid valve 23 is operated is indicative of a fault and may be processed by the oven control circuit 4. Accordingly, this fault indication may be used by the control circuit of the heater resistor 41 for deactivating the heater resistor 202 by cutting off the supply of power to it as a safety measure.

Additional safety is provided by the limiter 204, which informs the heater resistor control circuit 41 if a limit safety temperature equal to T2 is exceeded.

Throughout the cooking phase CS, regulating the water feed of the steam generator 2 is implemented in the manner just described above.

The steam evacuation phase EV typically has a duration of three minutes and starts at the end of the cooking phase CS.

The steam evacuation phase EV enables evacuation of steam and drying of the walls of the enclosure 3 before opening a door of the enclosure 3.

During the phase EV, the heating blanket and the ventilation/cooling fan (not shown) remain energized by the oven control circuit 4. On the other hand, the oven control circuit 4 switches off the thermal activator 31 for opening of a valve of the enclosure 3.

According to the invention, it is possible during the phase EV to assure total evacuation by evaporation of any water remaining in the vessel 201 at the end of the cooking phase CS.

In order to evacuate the remaining quantity of water by evaporation, the heater resistor 202 remains energized during the phase EV up to the detection of a rise Atr in the temperature TB. The temperature rise Atr is detected by the sensor 203 in the same way as a temperature rise At during the cooking phase CS.

Detection of the temperature rise Atr informs the oven control circuit 4 of total evaporation of the remaining quantity of water. When the temperature rise Atr is detected, the heater resistor control circuit 41 commands the de-energization of the heater resistor 202.

A drying phase (not shown) typically having a duration of three minutes preferably follows the steam evacuation phase EV and begins after the door of the enclosure 3 is opened. In this way it is possible to dry the walls of the enclosure 3 perfectly.

1. Method of cooking with steam in a cooking oven (1) equipped with a steam generator (2, 4) comprising a water evaporation vessel (201) and a heater unit (200) in thermal contact with said water evaporation vessel (201), the method including a cooking phase (CS) during which feeding of water to said water evaporation vessel (201) is regulated and being characterized in that said water feed regulation comprises the steps of:
detecting an increase (At) of a temperature (TB) in said heater unit (200), and
triggering feeding of water to said water evaporation vessel (201) when said temperature increase (At) is detected.

2. Steam cooking method according to claim 1, characterized in that a temperature increase (At) corresponding to the evaporation of a predetermined quantity of water contained in the water evaporation vessel (201) is detected in said step of detecting a temperature increase in order to trigger said feed of water.

3. Steam cooking method according to claim 1, characterized in that it further includes a step of first feeding water to said water evaporation vessel (201) at the beginning (T0) of said cooking phase (CS).

4. Steam cooking method according to claim 1, characterized in that said temperature increase (At) is detected if said temperature (TB) exceeds a predetermined first threshold temperature (T1).

5. Steam cooking method according to claim 4, characterized in that said first threshold temperature (T1) is significantly higher than a stabilization temperature (T0) in said heater unit (200) reached when said water evaporation vessel (201) contains water and said heater unit (200) is heating said water evaporation vessel (201).

6. Steam cooking method according to claim 5, characterized in that said first threshold temperature (T1) is from approximately 110° C. to 130° C. and/or said stabilization temperature (T0) is from approximately 100° C. to 120° C.

7. Steam cooking method according to claim 4, characterized in that a deactivation of said heating unit (200) as a safety measure is decided on the basis of said first threshold temperature (T1) and/or a safety threshold temperature (T2) being exceeded in said heater unit (200).

8. Steam cooking method according to claim 1, characterized in that water is fed by opening a water feed circuit (21, 22, 23) for a predetermined time (D0).

9. Steam cooking method according to claim 1, characterized in that water is fed by gravity.

10. Steam cooking method according to claim 1, characterized in that it also includes, in a steam evacuation phase (EV), a step of continuing to heat said water evaporation vessel (201) until detection of a temperature increase (Atr) indicating that any water remaining in said water evaporation vessel (201) has completely evaporated.

11. Steam generator, in particular for a cooking oven, including a water evaporation vessel (201), a heater unit (200) in thermal contact with said water evaporation vessel (201) and means for regulating feeding of water to said water evaporation vessel (201), characterized in that said water feed regulation means include:
means for detecting (203) an increase (At) of a temperature (TB) in said heater unit (200), and
means for commanding (40, 23) feeding of water to said water evaporation vessel (201) if said temperature increase (At) is detected.

12. Steam generator according to claim 11, characterized in that said temperature increase detector means include means (203) for indicating that a first threshold temperature (T1) is exceeded in said heater unit (200).

13. Steam generator according to claim 11, characterized in that it also includes means (204) for indicating that a second threshold temperature (T2) is exceeded in said heater unit (200).

14. Steam generator according to claim 13, characterized in that said means for indicating that a first threshold temperature (T1) has been exceeded and said means for indicating that a second threshold temperature (T2) has been exceeded respectively comprise a temperature sensor (203) and a temperature limiter (204).

15. Steam generator according to claim 11, characterized in that said water feed control means include a solenoid valve (23) and a control circuit (40) adapted to command opening of said solenoid valve (23) for a predetermined time (D0) if it receives from said temperature increase detector means (203) information indicating detection of said temperature increase (At).

16. Steam generator according to claim 14, characterized in that said temperature sensor (203) and said temperature limiter (204) are mounted on said lower portion of said block of material in thermal contact with said block of material.

17. Steam cooking oven, characterized in that it implements a steam cooking method according to claim 1.

18. Steam cooking oven, characterized in that it includes a steam generator (2, 4) according to claim 11.

19. Steam cooking oven according to claim 17, characterized in that it includes:
a temperature probe (30) for measuring an enclosure temperature (TR) inside an enclosure (3) of the oven (1), and
a control circuit (4, 41) for regulating said enclosure temperature (TR) by controlling said heater unit (200) as a function of a set point temperature (CS)
and information supplied by said temperature probe (30).

20. Steam cooking method according to claim 2, characterized in that it further includes a step of first feeding water to said water evaporation vessel (201) at the beginning (T0) of said cooking phase (CS).
